(19) United States
(12) Patent Application Publication
(10) Pub. No.: US 2010/0100821 A1
(43) Pub. Date: Apr. 22, 2010

(54) WINDOW DETECTION SYSTEM AND METHOD FOR OPERATING THE SAME

(75) Inventors: TSUNG-HAN TSAI, Taipei City (TW); CHEN-WEI SU, Taipei City (TW); CHUN-PING FANG, Taipei City (TW); MIN-CHING WU, Taipei City (TW)

Correspondence Address: AIBELIVE CO., LTD., P.O.BOX 108-00403, TAIPEI, 106, TW

(73) Assignee: AIBELIVE CO., LTD., Taipei City (TW)

(21) Appl. No.: 12/253,907

(22) Filed: Oct. 17, 2008

(51) Int. Cl. G06F 3/16

(52) U.S. Cl. 715/728

(57) ABSTRACT

A window detection system is disclosed. The window detection system includes a CPU, a window detection module and a voice identification module. The window detection module has a virtual assistant for receiving signals from an external voice inputting unit and to process thereby. The window detection module is connected to a preset display for synchronized detection of the present work window among a plurality of windows in the display. When the voice inputting unit receives the user's voice command, the virtual assistant of the window detection system starts to process and judges the execution command, and then matches the voice command with the signal of the present work window in the display detected by the window detection module. The voice identification module searches through the CPU to retrieve the information from an internal database of the host. Thus matching with the present work window for displaying can be easily achieved via quick operation and accordingly upgrade the identification efficiency.

### BACKGROUND OF THE INVENTION

1. Field of the invention

The present invention relates to a window detection system; and more particularly to a window detection system for processing matching of a signal of a present work window on a display with an external voice inputted command, and searches to retrieve a voice information from an internal database of a host matching with a work window for further displaying on a display. The operation is simple and prompt with high identification efficiency.

2. Description of Related Art

A plurality of operation systems and the appliance programs are being created along with the well developed computers and internet technologies, and large amount of information processing work can be done by the computer and the software as well as various types of information may be retrieved. For increasing the convenience, several operation systems and appliance programs have windows for operating the interfaces, clicking the button of the mouse, and dragging or drop down the cursor to operate. The computer calculation is widely used to accordingly increase the number of the windows appliance software, for example, IE software program for browsing in the webpage, Word software program for processing documents, Excel software program for designing tables, Power Point software program for designing reports and Multi-Media Player for playing audio and video information, which play very important roles in producing the report, projection films and tables.

The windows displaying system only allow the user to use the cursor control device to control the movement of the cursor to activate various types of functions or the appliance programs in the windows interface. Because the various types of functions or the appliance programs in the windows interface are promptly developed, the operation thereof has become more complicated to conduct. The user can not memorize the locations on the windows interface of each and every one of the command even the windows displaying system provides several functions for easier operation, therefore, the trouble of not being acknowledged of finding one single command is often happens. Besides, some commands do not exist in the user's present windows interface, and the user has to exit the present window interface for opening and close a plurality of windows to execute another command. These defects have made the conventional windows displaying system harder to operate with the increasing complication.

Accordingly, a voice inputting control program has been created to allow the user to input sound for processing identification in the computer to simultaneously control a plurality of appliance programs in the windows to execute, for example, opening, saving or editing files. However, different computers have different operation systems or appliance programs, a plurality of windows of activated appliance programs stored in the computer and a mass of the indexing files may possibly share the same titles or terms. Then a plurality of windows activate on the screen to execute voice inputting control program, the appliance program of every window simultaneously picks up the indexing repeated file to display the files on the display. The user may be inconvenienced operating, for example, volume of the information indexed simultaneously by the appliance programs of a plurality of windows is larger, files displayed in the monitor at the same time is plural with complicated choices; a mass of the files searched within the computer takes a lot of time to execute and the speed is accordingly reduced, and the computer has to search a large number of files, and other phrases from a plurality of appliance programs at the same time. Thus, the accuracy of identification may be substantially reduced and cause inconvenience in operation.

Therefore, how to solve the above defects has become the important issue for the suppliers in the field.

### SUMMARY OF THE INVENTION

An object of the present invention is to provide a window detection system.

According to an aspect of the present invention, a window detecting module comprises a virtual assistant to receive and process an external voice inputting unit signal, and the window detection module is connected to a preset display for synchronizing the present work window signal of the desktop on the display. When the display opens a plurality of work windows, the voice inputting unit receives the user's voice command to let the virtual assistant of the window detection system to process, judge the accurate execution command, and match the voice command with the work window signal on the display detected by the window detection module. A voice identification module searches and retrieves the information from an internal database of the host through a CPU to complete displaying of the voice information matched with the present work window in the displaying monitor. Thus, the user can easily and quickly operate the window system with higher identification efficiency.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of a window detection system according to an embodiment of the present invention.

FIG. 2 is a flowchart illustrating a method for operating a window detection system according to an embodiment of the present invention.

### DETAIL DESCRIPTION OF THE INVENTION

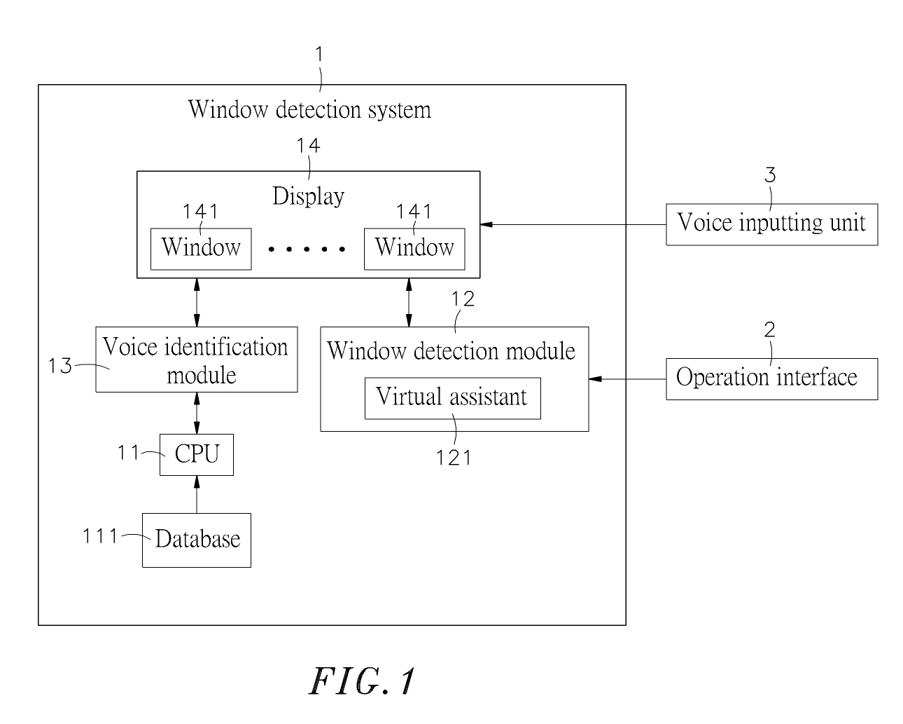

FIG. 1 is a block diagram of a window detection system according to an embodiment of the present invention. A window detection system 1 comprises a CPU 11, a window detection module 12, and a voice identification module 13. The window detection module 12 comprises a voice inputting unit 2 for receiving the external voice and a virtual assistant 121 for processing the voice, and the window detection module 12 is connected to a display 14 for synchronized detection of the signal of a present work window 141 on the display 14. The display 14 is connected to the voice identification module 13, and searches and retrieves the information from an internal database 111 of the host through the CPU 11 to complete displaying of the voice information matched with the present work window 141 on the display 14.

The window detection system 1 may be installed in a general electronic device, for example, a desktop computer or a notebook computer, and the CPU 11 of the window detection system 1 may be connected to the database in the electronic device to further establish an index and remarks, and while retrieving the information from the database by the CPU 11, the voice information matched with the signal of the work window 141 may be displayed on the display 14. The information in the index and remarks may be searched and retrieved for the matched keyword, synonym, terminology, word segmentation or other classified conditions, as well as for the user's defined thesaurus with numbers combined with the special symbols, for example, (1.) can be inputted by the voice as one comma to form a modular phrase, such as (1. one apple a day, for a long healthy life.) and other phrases.

The external voice inputted unit 2 may be a microphone connected to the host of the electronic device, and the microphone receives the user's voice command for the virtual assistant 121 to process. The voice identification module 13 can verify the voice and tone for processing matching and correction, or other voice identification functions.

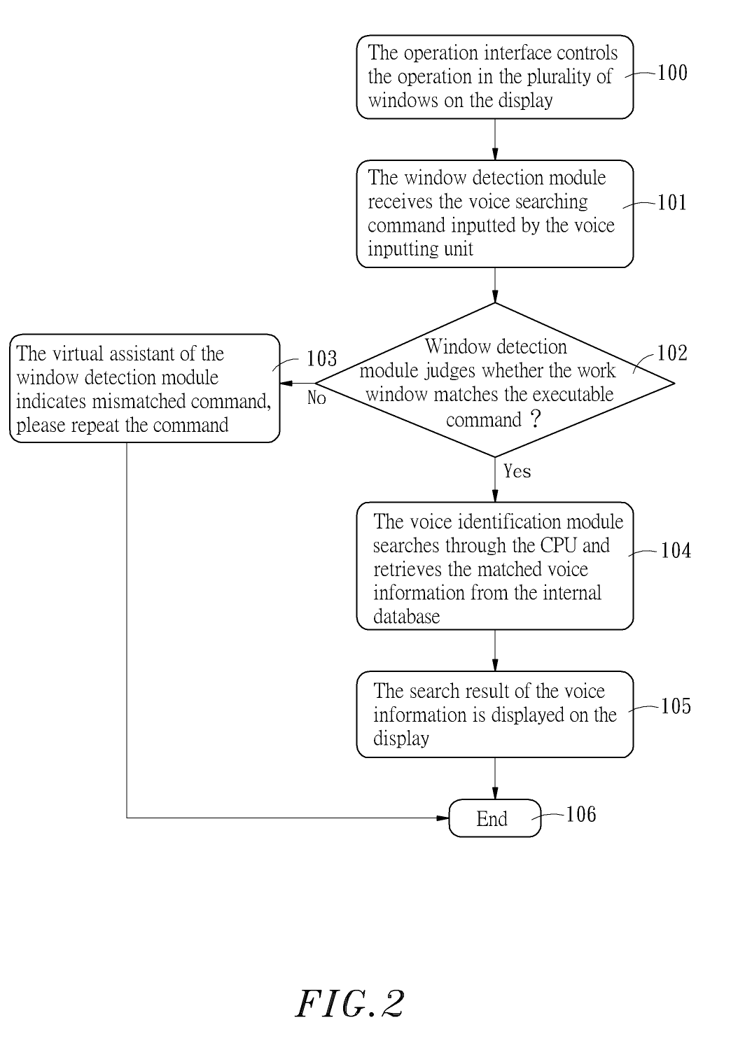

FIG. 2 is a flowchart illustrating a method for operating a window detection system according to an embodiment of the present invention, which comprises the following steps.

At step 100, an operation interface 3 controls the operation in the plurality of windows 141 on the display 14.

At step 101, the window detection module 12 receives the voice searching command inputted by the voice inputting unit 2.

At step 102, the window detection module 12 judges whether the work window 141 matches the executable command, wherein if the work window 141 matches with the executable command, the process proceeds to step 104, otherwise the process proceeds to step 103.

At step 103, the virtual assistant 121 of the window detection module 12 indicates mismatched command, please repeat the command; and process proceeds to step 106.

At step 104, the voice identification module 13 searches through the CPU 11 and retrieves the matched voice information from the internal database 111; and the process proceeds to step 105.

At step 105, the search result of the voice information is displayed on the display 14, and the process proceeds to step 106.

At step 106, the process is ended.

To operate the window detection system 1 of the present invention, the user can operate it via the operation interface 3, for example, touch panel, mouse, keyboard to control the plurality of windows 141 displayed on the display 14. The plurality of windows 141 can be in a format of Word, Excel, IE and Skype for operating of the window 141 in the operation interface 3. When the operation window 141 is in Word format, the user can input the voice command through the voice inputting unit 2, for example, to open the first file for an amount of money, the voice signal is transmitted to the window detection module 12 for receiving and converting the analog signal into digital signal, and the virtual assistant 121 receives for continuing the procedure. The window detection module 12 detects and judges whether the present work window 141 fits the executable command in the Word appliance program; wherein if it is judged that the present work fits the executable command in the Word appliance program, the voice identification module 13 starts searching through the CPU 11 and retrieves the matched voice information from the internal database 111 therein (to open the first file for an amount of money), to display on the display 14 for the user to operate. If the present work does not fit the executable command in the Word appliance program, the virtual assistant 121 reads out through the speaker or list on the display 14 as “Error command, please repeat the your command”.

The above display 14 provides a platform for the operation interface 3, for example, touch panel, mouse, keyboard, to control the operation in the window 141 of the display 14, and when the display 14 has no appliance program in the desktop, the user can still turn on the program of the window detection system 1 of the present invention. The window detection system 1 provides the user a scenario mode to operate. The virtual assistant 121 issues the instruction through the speaker or displays on the display 14 as “please say your command”, the user just has to aim the microphone and say command, open the IE, the voice identification starts to process gathering action (the command of opening the appliance program), the present work window 141 on the desktop activates the explorer, and the virtual assistant 121 issues the instruction through the speaker or displays on the display 14 as “please say the execution command for surfing the website”; the user can directly say the website title, for example, Yahoo, to process the gathering action (the website title), the website control command and the action command in the main menu. If the present work window 141 on the desktop is Skype program the window 141, to process the gathering action (Skype), the Skype control command and the action command in the main menu. The window detection module 12 notifies the voice identification main stream controlling module for the command signal that the user may operate through the operation interface 3 and the voice inputting unit 2 for voice identification gathering and switching in order to fit the scenario for the user to effectively reduce the words gather from the voice identification to accordingly enhance the identification efficiency.

The window detection system 1 of the present invention can build up an index and remarks by using the database stored in the memory (for example the hard disk) of the electronic device, for example, a desktop computer, a notebook computer or a PDA, for retrieving the matched information directly.

The virtual assistant 121 of the window detection system 1 of the present invention can interact with the user by voice or displaying the message on the window 141, and the virtual assistant 121 can display by the menu mode setup by the window detection module 12. The menu may contain one main menu region and sub menu connected to the main menu for the user to operate easily.

The plurality of windows 141 of the appliance program can be in the format of a report file (like Power Point), a document file (like Word, Excel), an illustration file (like BMP, GIF or JPG), an audio/video file (WMA, WMV, MPEG or AVI) or an explorer file (html); in the operation scenario of the present invention, the appliance program window 141 need not essentially appear in the display 14, the virtual assistant 121 of the window detection module 12 can display the message for interacting with the user as a user friendly manual operation interface.

The present invention has at least the following advantages.

The window detection module 12 of the window detection system 1 comprises the virtual assistant 121 to receive the signal from the external voice inputting unit 2, and the window detection module 12 is connected to the display 14 to synchronized detection of the signal of the present work window 141 on the display 14. When the display 14 opens the plurality of windows 141, the voice inputting unit 2 can receive the user's voice command to let the virtual assistant 121 of the window detection system 1 process, judge the accurate execution command, and then matches the voice command with the signal of the work window 141 in the display 14 detected by the window detection module 12. The voice identification module 13 directly searches through the CPU 11 to retrieve the information from the internal database 111 of the host, and thus completes voice information matched with the present work window 141 for displaying with an easy and prompt operation to accordingly enhance the identification efficiency.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A window detection system, comprising:
a CPU;
a window detection module, comprising a virtual assistant for receiving and processing an external signal from a voice inputting unit, connected to a preset display to synchronize detect signals of a present work window in said display with a voice command; and
a voice identification module, connected to said display, for searching through said CPU to retrieve information from a database of said host for matching with said present work window for displaying on said display.

2. The window detection system according to claim 1, wherein said CPU of said window detection system is connected to said database of said host, to build an index and remarks accordingly.

3. The window detection system according to claim 1, wherein said virtual assistant displays interacting messages on said display according to an operation scenario.

4. The window detection system according to claim 1, wherein said virtual assistant issues interacting messages through a speaker according to an operation scenario.

5. The window detection system according to claim 1, wherein said window detection module is connected to a voice identification main stream controlling module for notifying command signals of an external operation interface and said voice inputting unit to switch voice identification gatherings.

6. A method for operating window detection system comprising:
(1) an operation interface controlling operation in a plurality of windows in a display;
(2) a window detection module receiving a voice searching command inputted by a voice inputting unit;
(3) said window detection module judging using a work window matching an executable command;
(4) said voice identification module searching through a CPU and retrieving matched voice information from a internal database thereof; and
(5) displaying a search result of said voice information on said display.

7. The method for operating a window detection system according to claim 6, wherein said window detection module processes said voice signal through a connected virtual assistant.
